(19) United States
(12) Patent Application Publication
(10) Pub. No.: US 2007/0252356 A1
(43) Pub. Date: Nov. 1, 2007

(54) Combination bicycle and scooter

(76) Inventors: Kenneth A. Tarlow, Corte Madera, CA (US); James Allan Douglas, New York, NY (US)

Correspondence Address: KENNETH A. TARLOW, 21 GOLDEN HIND PASSAGE, CORTE MADERA, CA, 94925, US

(21) Appl. No.: 11/412,891

(22) Filed: Apr. 28, 2006

(51) Int. Cl. B62M 1/02

(52) U.S. Cl. 280/259

(57) ABSTRACT

Combination bicycle and scooter having an eight inch diameter front wheel and a twelve inch diameter rear wheel, where by means of a double drive sprocket assembly, a person can pedal in a normal way and achieve speeds associated with a standard bicycle having twenty-six inch diameter wheels. The steering stem is hinged where it meets the longitudinal frame member. The frame member can telescope inward so that the entire bicycle and scooter assembly can fold down to approximately forty-two inches long, thirteen inches tall and nine inches wide, making it easy to transport in a vehicle such as an automobile, bus, train, boat or plane. A foot plate mounted on top of the longitudinal frame member allows the user to use the device as a standard scooter.

### CROSS REFERENCE TO RELATED APPLICATIONS

Not Applicable

### STATEMENT REGARDING FEDERALLY SPONSORED RESEARCH OR DEVELOPMENT

Not Applicable

Description of Attached Appendix

Not Applicable

### BACKGROUND OF THE INVENTION

This invention relates generally to the field of two wheeled human powered vehicles and more specifically to a combination bicycle and scooter. Bicycles are well known to be two wheeled vehicles where the user sits on a seat, places his or her feet on crank pedals and by a circular pedaling motion causes the vehicle to be propelled forward. A human powered scooter is also a well known device which generally includes a rather small front and rear wheel assembly and a longitudinal frame member that includes a flat surface for the user to place one or both feet. The user propels forward by pushing on the ground with one foot while the other foot is resting on the flat foot plate.

In the prior art, a number of inventors have tried to combine the benefits of a bicycle and a scooter. For example, William Ehrlich in his U.S. Pat. No. 4,763,913 shows a bicycle scooter combination where a frame accommodates standard large diameter bicycle wheels and crank pedal assembly but also includes a lower platform in the frame which allows the user to stand on the platform so that the entire assembly can be used as a scooter when so desired. Eric Zaccagnini in his U.S. Pat. No. 6,832,774 discloses a vehicle that can convert between a bicycle and a scooter which small scooter type wheels, a standard pedal crank arm assembly and bicycle seat assembly as well as a platform located at the lower portion of the frame so that the user can stand on to operate in the scooter mode. The Ehrlich patent, does combine features of a bicycle and a scooter, however, the large diameter bicycle type wheels of this design limit the ability of the user to easily store the invention in a small space such as the trunk of an automobile or to carry it onto public transportation such as a bus, train or plane. The Zuccagnini patent also combine features of a bicycle and a scooter. The invention uses smaller scooter type wheels and has folding capability so that it can be stored in a small space. However, The location of the crank arm with respect to the seat means that this device can only be used comfortably by small children. Additionally, because of the small diameter of the rear wheel and the standard configuration of a single large sprocket at the crank arm attached by a chain to a standard small sprocket mounted to the rear wheel, the user would have to pedal furiously fast to approach the normal speed of a standard bicycle which has twenty-four or twenty-six inch diameter tires.

### BRIEF SUMMARY OF THE INVENTION

The primary object of the invention is to provide a human powered scooter, having an approximately twelve inch rear wheel and an approximately eight inch front wheel, that can be pedaled like a standard bicycle and can travel at speeds similar to that of a standard bicycle that has twenty-six inch wheels.

Another object of the invention is to provide a combination bicycle and scooter whose frame length and handle bar height can be adjusted to accommodate riders of different heights.

Another object of the invention is to provide a combination bicycle and scooter whose length can be shortened to allow for compact transport and storage.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed combination bicycle and scooter comprising: a longitudinal frame member, a front scooter wheel assembly, a standard front fork assembly, a standard rear fork assembly, a steering stem, a hand gripping bar, a rear scooter wheel assembly, a first large drive sprocket, a first small drive sprocket, a second large drive sprocket, a second small drive sprocket, a first drive shaft, a second drive shaft, a first drive chain, a second drive chain, a standard crank arm assembly and crank pedals, one end of said frame member terminating in said front fork assembly, one end of said frame member terminating in said rear fork assembly, said front wheel shaft affixed to apertures in the legs of said front fork assembly, said rear wheel shaft affixed to slots in said rear wheel assembly, said steering stem hingedly attached to the rotatable stem in said front fork assembly, said hand gripping bar centrally attached in a T fashion to the top of said steering stem, said first large drive sprocket attached by said first drive shaft though a first aperture in said frame member, said first small drive sprocket and said second large drive sprocket concentrically mounted via said second drive shaft to a second aperture in said frame member, said second small drive sprocket concentrically mounted on said rear wheel assembly, said first drive chain attaching said first large drive sprocket to said first small drive sprocket, said second drive chain attaching said second large drive sprocket to said second small drive sprocket, said crank arm assembly and attached pedals centrally attached to said first large drive sprocket and the exterior of the cross tube of said crank arm assembly fixedly attached to said longitudinal frame member.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention in the use position

FIG. 2 is a partial side view of the invention.

FIG. 3 is a partial top view of the invention.

FIG. 4 is a partial side section view of the invention.

FIG. 5 is a perspective view in the stored position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

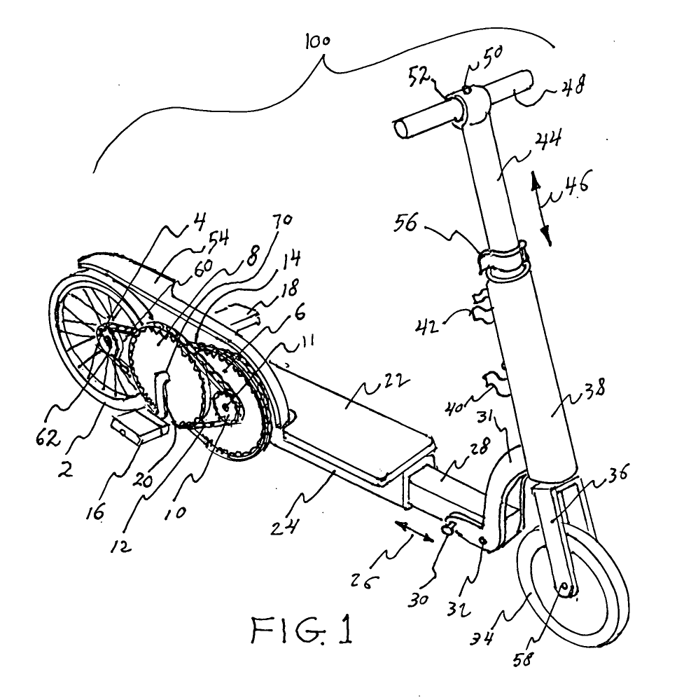

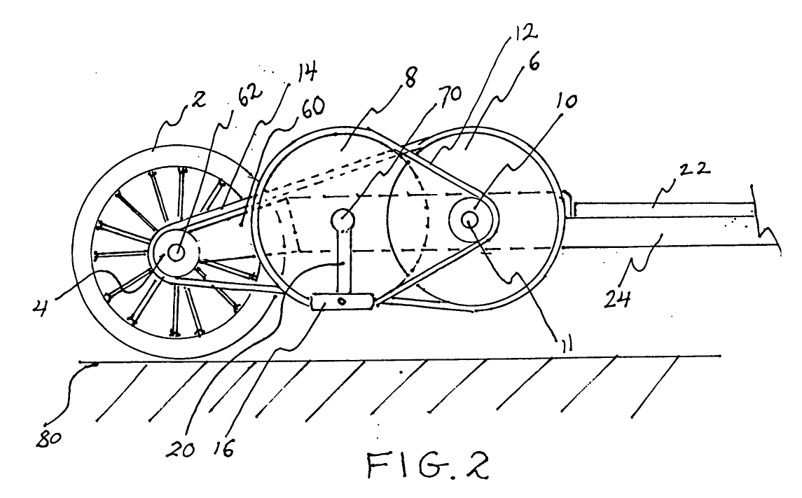

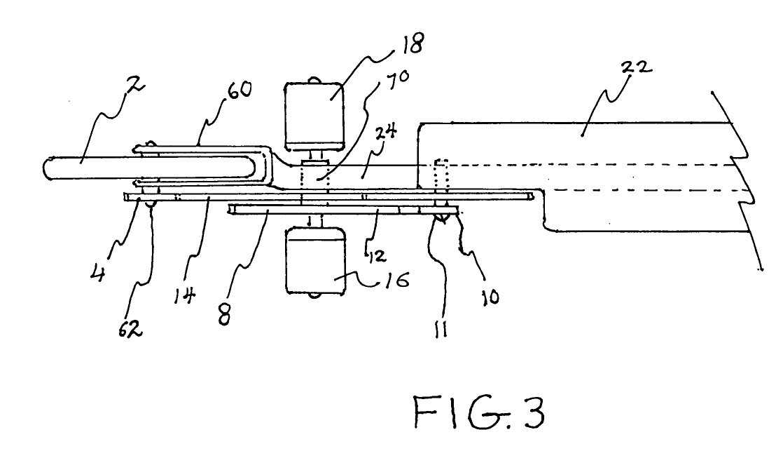

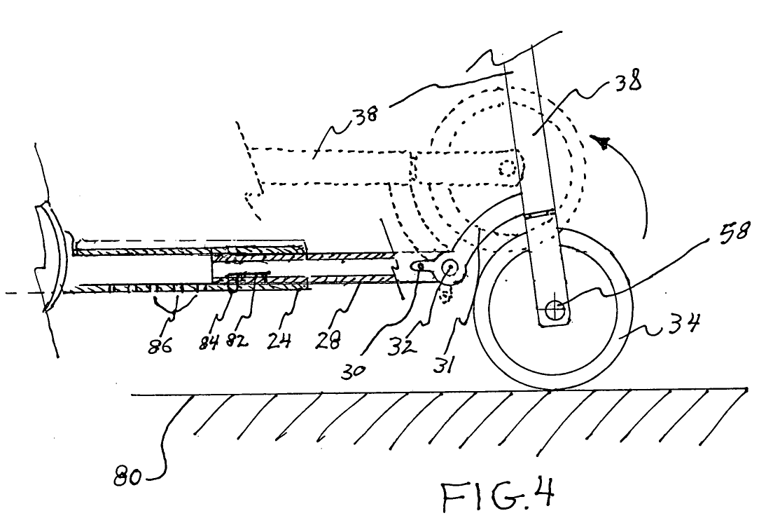

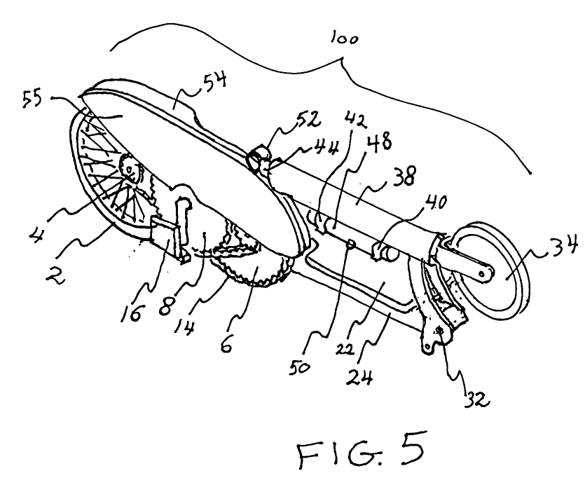

Referring now to FIG. 1 we see a perspective view of the invention 100 in the use position. The invention has elements of both a bicycle and a scooter assembled iri a novel manner. The invention's 100 rear wheel 2 is approximately twelve inches in diameter. The invention's front wheel is approximately eight inches in diameter. The overall length of the invention 100 is approximately fifty inches when the longitudinal frame member 24, 28 is fully extended so that it can be easily used by an adult. The steering column 38, 44 can be adjusted up or down as shown by arrow 46. By swinging out adjustment lever 56, top steering column 44 can be slid up and down. Swinging the adjustment lever 56 in towards the column 44 causes the top steering column 44 to lock in place. Because of the relatively small diameter of the rear wheel 2, compared to a normal adult bicycle twenty-six inch diameter wheel, a standard bicycle chain sprocket system consisting of one large sprocket on the crank assembly and one small sprocket on the rear wheel assembly is not sufficient to drive the present invention 100 at normal bicycle speeds. Using the standard system described, the user would have to pedal furiously fast to begin to approach normal adult bike speeds. Even the use of a standard gear cluster as found on many adult bikes would not produce optimal speed because the ratio of the large sprocket to the smallest sprocket in the cluster would not be great enough. If one tried to make the crank shaft gear large enough to produce optimal adult bike speeds, it would have to be approximately sixteen inches in diameter thereby forcing the scooter platform 22 to be approximately eleven inches off the ground, making it difficult to be used as a scooter, as well making it difficult to carry and store the invention in a compact manner. To solve the problem of increasing speed while maintaining a small rear wheel 2 diameter and maintain a low platform 22 height as well as overall compactness for storage and carrying purposes, the present invention 100 uses a double sprocket system where a first large drive sprocket 8 is attached by a crank arm drive shaft 70 through a first aperture in the frame member 24. A first small drive sprocket 10 and a second large drive sprocket 6 are concentrically mounted by a second drive shaft 11 through a second aperture in the frame member 24. A second small drive sprocket 4 is concentrically mounted to the shaft assembly of the rear wheel 2. A first drive chain 12 attaches the first large drive sprocket 8 to the first small drive sprocket 10. A second drive chain 14 connects the second large drive sprocket 6 to the second small drive sprocket 4. These relationships can be more clearly seen in FIG. 2. The first and second large drive sprockets 6, 8 are approximately eight and one half inches in diameter. The first and second small drive sprockets are approximately three inches in diameter. The crank arms 20 are approximately four inches long and terminate in pedals 16, 14. Because of the layout of the drive sprockets and crankshaft as shown and described, the height if scooter deck plate 22 is approximately six inches from the ground, which is manageable when using the invention 100 as a standard kick scooter. FIG. 3 shows a partial top plan view of the invention 100. Rear wheel fork 60 can be clearly seen as well as first drive shaft 70 and second drive shaft 11. First drive chain 12 can be seen as outboard of second drive chain 14. Scooter deck plate 22 is mounted to longitudinal frame member 24 and extends further towards the rear wheel on the pedal 18 side to give the user more foot room when using the invention 100 as a kick scooter. FIG. 4 is a partial section view of the invention showing how the longitudinal frame member is comprised of two telescoping tubes 24, 28. Tube 24 has a plurality of apertures 86 on its bottom that can accept a spring 82 biased pin 84 so that the user can adjust the overall length of frame member 24, 28 to accommodate the size of the user and to make the length of the frame 24, 26 as short as possible for storage and transport. The shortest overall length of the invention is approximately forty-two inches, which is small enough to easily fit in a person's vehicle trunk or to be carried onto public transport such as a bus, train, or plane. The front fork and steering stem assembly 38 can be rotated down about shaft 32 as shown in the dotted line drawing by removing locking pin 30 from its aperture in frame member 28. FIG. 5 shows a perspective view of the invention 100 in the folded position. For maximum compactness, handle bar 48 has been removed from aperture 52 by pressing on spring biased post 50 and then stored in C clips 40, 42. Additionally, pedals 16, 18 fold up thereby decreasing the overall width of the invention to approximately nine inches. The folded height of the invention is approximately thirteen inches. Chain guard 54, 55 protects the user from having his or her clothing being caught in the drive chains 12, 14.

The above described and illustrated invention provides a novel way to combine the best aspects of a scooter and bicycle, that is, to maintain the compact size of a standard scooter while having the ability to pedal at adult bicycle type speeds.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. combination bicycle and scooter comprising:
a longitudinal frame member;
a front scooter wheel assembly;
a standard front fork assembly;
a standard rear fork assembly;
a steering stem;
a hand gripping bar;
a rear scooter wheel assembly;
a first large drive sprocket;
a first small drive sprocket;
a second large drive sprocket;
a second small drive sprocket;
a first drive shaft;
a second drive shaft;
a first drive chain;
a second drive chain;
a standard crank arm assembly and crank pedals;
one end of said frame member terminating in said front fork assembly;
one end of said frame member terminating in said rear fork assembly;
said front wheel shaft affixed to apertures in the legs of said front fork assembly;
said rear wheel shaft affixed to slots in said rear wheel assembly;
said steering stem hingedly attached to the said longitudinal frame member;
said hand gripping bar centrally attached in a T fashion to the top of said steering stem;
said first large drive sprocket attached to said crank shaft which is rotatably held by apertures in said frame member;
said first small drive sprocket and said second large drive sprocket concentrically mounted via said second drive shaft which is rotatably held within a second aperture in said frame member;
said second small drive sprocket concentrically mounted on said rear wheel assembly;
said first drive chain attaching said first large drive sprocket to said first small drive sprocket;
said second drive chain attaching said second large drive sprocket to said second small drive sprocket;
said crank arm assembly and attached pedals centrally attached to said first large drive sprocket and
the exterior of the cross tube of said crank arm assembly fixedly attached to said longitudinal frame member.

2. Combination bicycle and scooter as claimed in claim 1 wherein said longitudinal frame member is comprised of a pair of slidable telescoping tubes so that the length of the frame member can be adjusted and fixed in place by standard means such as a spring pin or a clamp.

3. Combination bicycle and scooter as claimed in claim 1 wherein said longitudinal frame member includes a top plate positioned to accept the foot of the user.

4. Combination bicycle and scooter as claimed in claim 1 further comprising a chain guard enclosing the top portions of said sprockets and a portion of said rear wheel.

5. Combination bicycle and scooter as claimed in claim 1 wherein said front wheel is approximately eight inches in diameter and said rear wheel is approximately twelve inches in diameter.

6. Combination bicycle and scooter as claimed in claim 1 wherein the configuration of said first and second drive sprockets and said drive chains allow the user to pedal in a normal way and yet achieve speeds equal to that of a bicycle having twenty-six inch wheels.

7. Combination bicycle and scooter as claimed in claim 1 wherein the said pedals can be easily folded up to reduce the overall width of the said invention during transport and storage.

8. Combination bicycle and scooter as claimed in claim 1 wherein said bicycle and scooter combination can be reduced, by means of said hinged steering stem, said telescoping frame member and said folding pedals, to a size of approximately forty-two inches long by thirteen inches tall by nine inches wide.
